(19) United States
(12) Patent Application Publication
(10) Pub. No.: US 2003/0131275 A1
(43) Pub. Date: Jul. 10, 2003

(54) Microcontroller and system having a clock generator

(76) Inventor: Jong-Hong Bae, Ichon-Shi (KR)

Correspondence Address: JACOBSON HOLMAN, PROFESSIONAL LIMITED LIABILITY COMPANY, 400 SEVENTH STREET, N. W., WASHINGTON, DC, 20004, US

(21) Appl. No.: 10/040,898

(22) Filed: Jan. 9, 2002

(51) Int. Cl. G06F 1/04

(52) U.S. Cl. 713/500

(57) ABSTRACT

Disclosed is a microcontroller, comprising: a clock input pin, wherein an input signal from the external circuit is inputted; a clock generator for generating a clock signal by receiving a signal from the clock input pin; a clock output pin for receiving an output signal of the clock generating means and outputting the output signal; a first switch for transmitting an internal signal of a microcontroller to the clock output pin for using the clock output pin is in a system mode; and a second switch, which is enabled when the clock generating means is operated in the clock generation mode and disabled when the microcontroller is operated in the system mode.

### FIELD OF THE INVENTION

The present invention relates to a microcontroller; and, more particularly, to a microcontroller having a low noise clock generator for an interface between an internal clock generator and a system having the microcontoroller.

### DESCRIPTION OF THE PRIOR ART

Generally, microcontroller is synchronized with the clock and such clock is applied from the external circuit or generated in the microcontroller.

Thus, in case that the clock generator is built in the microcontroller, the clock signal is amplified by inputting a stable small signal of a crystal oscillator.

However, a microcontroller development system (MDS) is a microcomputer system for testing the hardware or software of the proto type of the microcontroller built-in system. The MDS includes a processor module, a console, a printer, an emulator and a programmable memory.

FIG. 1 is a circuit diagram of a clock generator and its external devices in accordance with the prior art.

Referring to FIG. 1, the microcontroller 10 includes a clock input pin XTAL_in, a clock output pin XTAL_out and an internal clock generator 11. In FIG. 1, the internal clock generator 11 includes an inverter 11A having the clock input pin XTAL_in and the clock output pin XTAL_out and a bias resistor 11B, which is connected to input and output terminals of the inverter 11A. The clock input and output pins XTAL_in and XTAL_out of the internal clock generator 11 includes a quartz crystal oscillator 33 for generating a clock signal and capacitors 31 and 32 for reducing the noise effect. The quartz crystal oscillator 33 and capacitors 31 and 32 are formed outside of the microcontroller 10.

The clock signal generated from the quartz crystal oscillator 33 is a small signal having an insignificant electric potential level and the internal clock generator transforms the small signal as a full-swing clock signal. That is, the small signal is inputted to the clock input pin XTAL_in, inverted by the inverter 11A and pulled-up or pulled-down to the internal electric potential level of the microcontroller 10 so that the small signal is outputted to the clock output pin XTAL_out.

After outputting the small signal, an output signal of the clock output pin XTAL_out is performed feedback to the quartz crystal oscillator 33 again so that the output signal is applied to the internal circuit of the microcontroller 10 as a clock signal.

However, if the microcontroller 10 is built in the MDS equipment to drive as a System mode, a MDS data output pin is required.

### SUMMARY OF THE INVENTION

It is, therefore, an object of the present invention to provide a microcontroller and system having a clock generator.

In accordance with an aspect of the present invention, there is provide a microcontroller, comprising: a clock input pin, wherein an input signal from the external circuit is inputted; a clock generating means for generating a clock signal by receiving a signal from the clock input pin; a clock output pin for receiving an output signal of the clock generating means and outputting the output signal; a first switch for transmitting an internal signal of a microcontroller to the clock output pin for using the clock output pin is in a system mode; and a second switch, which is enabled when the clock generating means is operated in the clock generation mode and disabled when the microcontroller is operated in the system mode.

In accordance with another aspect of the present invention, there is provide a system having a microcontroller, comprising: a clock input pin for receiving an input signal; a first clock generating means for receiving a signal from the clock input pin to generate a clock signal; a first switch for transmitting an internal signal of a microcontroller to the clock output pin for using the clock output pin is in a system mode; a second switch, which is enabled when the clock generating means is operated in the clock generation mode and disabled when the microcontroller is operated in the system mode; and a second clock generating means for providing a clock signal to the microcontroller through the clock input pin in a system mode.

### BRIEF DESCRIPTION OF THE DRAWINGS

The above and other objects and features of the instant invention will become apparent from the following description of preferred embodiments taken in conjunction with the accompanying drawings, in which:

FIG. 1 is a circuit diagram of a clock generator and its external devices in accordance with the prior art;

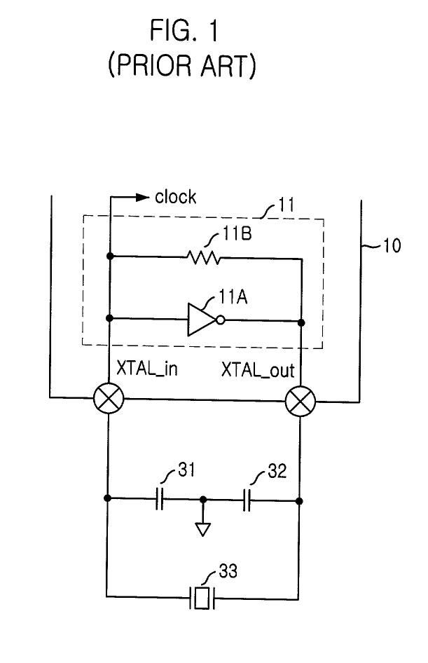

FIG. 2 is a circuit diagram of a microcontroller and microcontroller development system (MDS) in accordance with the first embodiment of the present invention showing the share of the internal signal EA with the clock pins; and

FIG. 3 is a circuit diagram of a microcontroller and MDS system having a built-in low noise clock generator in accordance with the second embodiment of the present invention.

### DETAILED DESCRIPTION OF THE PREFERRED EMBODIMENTS

Hereinafter, a microcontroller and system having a clock generator according to the present invention will be described in detail referring to the accompanying drawings.

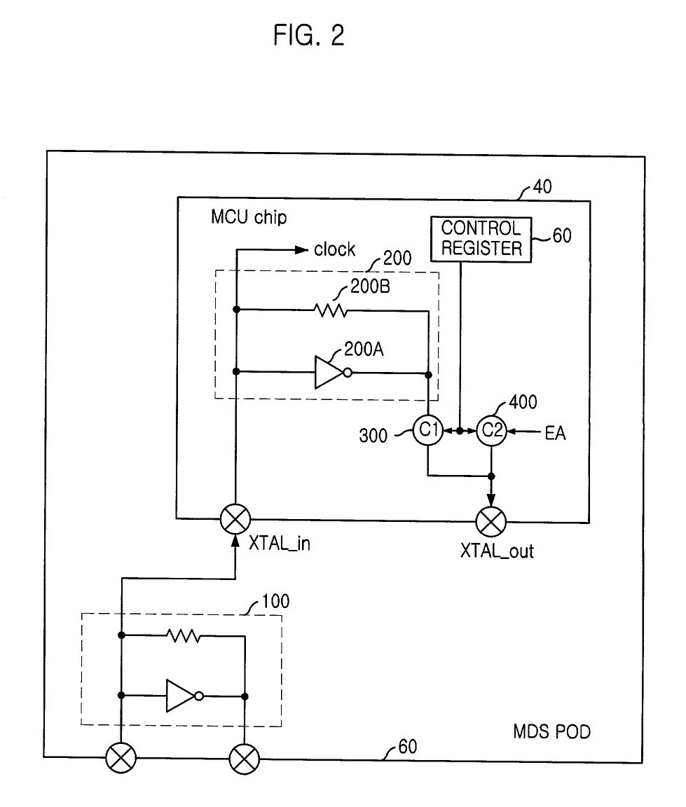

FIG. 2 is a circuit diagram of a microcontroller and microcontroller development system (MDS) in accordance with the first embodiment of the present invention showing the share of the internal signal EA with the clock pins.

Referring to FIG. 2, a microcontroller 40, also known as MCU chip, is built in the MDS and a separate clock generator 200 is included outside of the microcontroller 40 to provide a clock to the microcontroller 40.

The microcontroller 40 includes a clock input pin XTAL_in, a clock generator 200 for generating a clock signal by receiving a signal from the clock input pin XTAL_in and amplifying the signal as a full-swing, a clock output pin XTAL_out for outputting an output signal received from the clock generator 200 to the system, switches 300 and 400 and a control register 500 for outputting a mode selecting signal in order to selectively drive switches 300 and 400.

When the microcontroller 40 is operated in the System mode, the switch 400 sends an internal signal EA of the microcontroller 40 to the clock output pin XTAL_out. However, the switch 400 is disabled when the clock generator 200 in the microcontroller 40 is operatred in a clock generation mode. The switch 300 is connected between an output node of the clock generator 200 and the clock output pin XTAL_out. However, the switch 300 is enabled when the clock generator 200 is operated in the clock generation mode and disabled when the microcontroller 40 is operated in the System mode.

Thus, the present invention includes the separate clock generator 100 and the clock output pin XTAL_out in the microcontroller 40 is selectively used in the System mode and the clcok generation mode. Therefore, the microcontroller 40 having the built-in internal clock generator 200 can be loaded into the special equipment, such as the MDS equipment, so that the data output pin is not required.

In the FIG. 2, the clock generator 200 includes an inverter 200A for amplifying an input signal as a full-swing to generate a clock signal and a resistor 200B, which is connected to input and output terminals of the inverter 200A.

The switch 400 is enabled when the microcontroller 40 is operated in the System mode and the switch 300 is enabled when the clock generator 200 is operated in the clock generation mode by the control register 500.

In accordance with the first embodiment of the present invention, the mode selecting signal is generated by the control register 500 in the microcontroller. However, instead of using the control register 500, the separate control circuit can be replaced in the MDS to control switches 300 and 400.

In the clock generation mode, the clock signal of the small signal level inputted from the external quartz crystal oscillator, which is not shown in FIG. 2, is amplified in the clock generator 200 through the clock input pin XTAL_in. After amplifying the clock signal, the clock signal is applied to the input terminal of the switch 300 by the mode selecting signal so that the clock signal is performed feedback to the external quartz crystal oscillator through the clock output pin XTAL_out. In the external quartz crystal oscillator, the clock signal is applied to the input terminal of the clock generator 41 in the microcontroller again in order to generate the internal clock signal. At this time, the switch 400 is disabled.

In the System mode, the internal signal EA is outputted through the clock output pin XTAL_out by the switch 400, which is enabled by the mode selecting signal. At this time, the clock generator 200 is not operated, therefore, the clock signal is provided from the separate clock generator 100.

However, the frequency characteristic of the microcontroller is determined and the constant output amplitude is maintained up to the maximum operating frequency at the initial design so that the noise in the microcontroller and the MDS system is amplified to maintain the constant amplitude.

At this time, if the clock applied to the microcontroller or the MDS system is below to the maximum operating frequency, the noise in the unnecessary frequency bandwidth is also amplified.

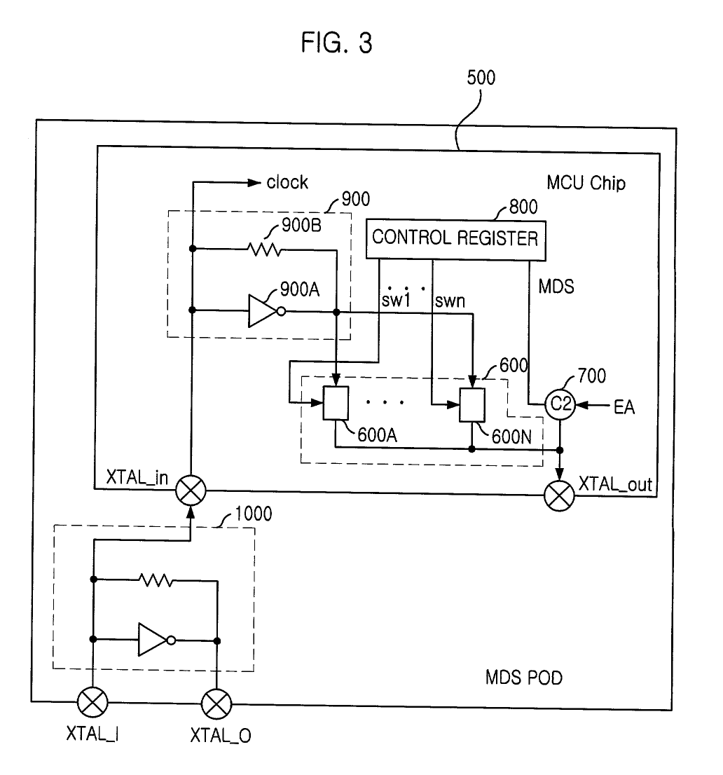

FIG. 3 is a circuit diagram of a microcontroller and MDS system having a built-in low noise clock generator in accordance with the second embodiment of the present invention.

Referring to FIG. 3, a switch unit 600 is included in contrast with the switch 300 in FIG. 2. In the switch unit 600, a plurality of switches 600A through 600N connected in parallel is implemented. The switch unit 600 is enabled by a control register 800 in a clock generation mode. However, each of switches 600A through 600N in the switch unit is selectively controlled by the control register 800 using each of control signals sw1 through sw2.

Thus, the switch 700 is enabled and each of switches 600A through 600N is disabled by the control register 800 in the System mode. At this time, a clock signal is provided to the microcontroller 500 by an internal clock generator 1000.

When a clock generator 900 is operated in a clock generation mode, the switch 400 is disabled and the number of enabled switches in each of switches 600A through 600N in the switch unit 600 is determined depending on a clock frequency. That is, the noise can be under control by controlling the current between the clock output pin XTAL_out and an output node of the clock generator 900.

However, instead of using the control register 800, the separate control circuit can be replaced in the MDS to control switch unit 600 and switch 700. Furthermore, the control circuit for controlling the switch 700 can be built in the microcontroller 500 and the control circuit for controlling the switch unit 600 can be built in the MDS.

The present invention can be applied not only to the MDS, but also to the system or emulator where the microcontroller is used.

In the present invention, the efficient system can be developed by sharing the internal signal EA with the clock pins. Furthermore, a low noise internal clock generating circuit can be provided by controlling the current of the internal clock generator.

While the present invention has been described with respect to the particular embodiments, it will be apparent to those skilled in the art that various changes and modifications may be made without departing from the spirit and scope of the invention as defined in the following claims.

What is claimed is:

1. A microcontroller, comprising:
a clock input pin, wherein an input signal from the external circuit is inputted;
a clock generating means for generating a clock signal by receiving a signal from the clock input pin;
a clock output pin for receiving an output signal of the clock generating means and outputting the output signal;
a first switch for transmitting an internal signal of a microcontroller to the clock output pin for using the clock output pin is in a system mode; and
a second switch, which is enabled when the clock generating means is operated in the clock generation mode and disabled when the microcontroller is operated in the system mode.

2. The apparatus as recited in claim 1, wherein the second switch includes a plurality of switches connected in parallel.

3. The apparatus as recited in claim 2, further comprising a control means for selectively controlling each of switches depending on a clock signal of the clock input pin.

4. The apparatus as recited in claim 1, further comprising a control means for selectively enabling first and second switches classified by modes.

5. The apparatus as recited in claim 2, further comprising a control means for selectively controlling each of switches depending on a clock signal of the clock input pin and selectively enabling first and second switches classified by modes.

6. The apparatus as recited in claim 1, wherein the clock generating means includes:
an inverter for amplifying an input signal as a full-swing to generate a clock signal; and
a resistor, which is connected to input and output terminals of the inverter.

7. A system having a microcontroller, comprising:
a clock input pin for receiving an input signal;
a first clock generating means for receiving a signal from the clock input pin to generate a clock signal;
a first switch for transmitting an internal signal of a microcontroller to the clock output pin for using the clock output pin is in a system mode;
a second switch, which is enabled when the clock generating means is operated in the clock generation mode and disabled when the microcontroller is operated in the system mode; and
a second clock generating means for providing a clock signal to the microcontroller through the clock input pin in a system mode.

8. The apparatus as recited in claim 7, wherein the second switch includes a plurality of switches connected in parallel.

9. The apparatus as recited in claim 8, further comprising a control means, which is placed in either inside or outside of the microcontroller, for selectively controlling each of switches depending on a frequency of a clock signal of the clock input pin.

10. The apparatus as recited in claim 7, further comprising a control means, which is placed in either inside or outside of the microcontroller, for selectively controlling each of switches depending on a clock signal of the clock input pin and selectively enabling first and second switches classified by modes.

11. The apparatus as recited in claim 8, further comprising a control means, which is placed in either inside or outside of the microcontroller, for selectively controlling each of switches depending on the frequency of the clock signal of the clock input pin and for selectively controlling each of switches depending on a clock signal of the clock input pin and selectively enabling first and second switches classified by modes.
